(19) United States
(12) Patent Application Publication
(10) Pub. No.: US 2016/0199861 A1
(43) Pub. Date: Jul. 14, 2016

(54) APPLICATOR FOR APPLYING ADHESIVE

(71) Applicant: Apparel Machinery Services, Inc., Port St. Lucie, FL (US)

(72) Inventors: Ronald Boser, Port St. Lucie, FL (US); Brian Scannell, Port St. Lucie, FL (US)

(73) Assignee: APPAREL MACHINERY SERVICES, INC., Port St. Lucie, FL (US)

(21) Appl. No.: 14/594,537

(22) Filed: Jan. 12, 2015

(51) Int. Cl. B05B 9/04; B05B 9/01; B05C 11/115; B05B 9/00

(52) U.S. Cl. CPC B05B 9/0413; B05B 9/002; B05B 9/01; B05C 11/115

(57) ABSTRACT

A system for dispensing a flowable material from a cartridge body includes a housing for receiving the cartridge body. A nozzle, which is attachable to or integral with a dispensing end of the cartridge body, includes an outer surface and an inner surface, which defines a passageway for the flowable material. A flow control block is attachable to the housing and includes an inner surface defining in inlet passage and an outlet passage. The inlet passage is sized to receive at least a portion of the nozzle therein. The inner surface of the flow control block is configured to mate with the outer surface of the nozzle in a sealing relationship when at least a portion of the nozzle is disposed within the inlet passage.

### BACKGROUND OF THE INVENTION

The use of flowable materials, such as hot melt adhesives, thermoplastics, and resins, for example, is widespread in the manufacture and assembly of goods, such as textiles, packaging, and the like. Such flowable materials generally begin as raw materials in the form of solid pellets or highly viscous compounds, for example, which are heated into a flowable mass and deposited onto a targeted workpiece.

Various manufacturing equipment has been developed for depositing such material. However, much of this equipment is quite large and occupies a large footprint making them unsuitable for individual use within individual work spaces. In addition, the raw material is often melted directly within and transferred through the structure of the equipment making cleaning and maintenance a tedious operation, which can lead to significant downtime.

Certain handheld devices for dispensing flowable material currently exist, which are generally in the form of a gun. These devices generally store raw materials in hoppers or cartridges from which the flowable material is ejected upon the actuation of a trigger mechanism. However, these devices require at least one hand to operate and prolonged use can lead to muscle fatigue and/or repetitive motion injuries, such as carpal tunnel. Moreover, these devices may still require significant clean-up after use and often lack precise control over the deposition location and amount of material being deposited.

### BRIEF SUMMARY OF THE INVENTION

In one aspect of the disclosure, a system for dispensing a flowable material from a cartridge body includes a housing for receiving the cartridge body. Also included in the system is a nozzle, which is one of attachable to or integral with a dispensing end of the cartridge body and has an inner surface that defines a passageway for the flowable material and an outer surface. A flow control block is attachable to the housing and includes an inner surface that defines an in inlet passage and an outlet passage. The inlet passage is sized to receive at least a portion of the nozzle therein. The inner surface of the flow control block is configured to mate with the outer surface of the nozzle in a sealing relationship when at least a portion of the nozzle is disposed within the inlet passage.

Additionally, the housing may include an inner surface that defines a cavity for receipt of the cartridge body and a first end with a first cap attached thereto. The first cap may have an opening in communication with the cavity. The opening may be sized to allow passage of the at least a portion of the nozzle through the opening while prohibiting passage of the cartridge body. The flow control block may be attachable to the first end of the housing such that the inlet passage aligns with the opening of the first cap. The housing may include a second end that has a second cap attachable thereto. The second cap may be movable from a first position to a second position in which the second cap presses against the cartridge body when the cartridge body is at least partially disposed within the cavity of the housing. The second cap may be attached to the second end via a linkage system that includes a plurality of pivot locations. When the second cap is in the second position at least three of the plurality of pivot locations may substantially align in a linear alignment to lock the second cap into the second position.

Continuing with this aspect, the housing may include a locking ring at a first end thereof having an open position and a closed position. The flow control block may include a mounting adapter positionable within the locking ring. When the mounting adaptor is positioned with the locking ring, the locking ring and flow control block may be rotatable with respect to the housing while the locking ring is in the open position and prohibited from rotation with respect to the housing while the locking ring is in the closed position.

Further, the outer surface of the nozzle may include a first tapered region and the inner surface of the flow control block may include a second tapered region. The first and second tapered regions may be correspondingly tapered. Alternatively, the outer surface of the nozzle may define a first mating region that is normal to a longitudinal axis defined by the passageway of the nozzle, and the inner surface of the flow control block may include a second mating region that is normal to a longitudinal axis defined by the inlet passage. The first and second mating regions may be correspondingly sized so as to compress a gasket therebetween.

Moreover, the inlet passage may be orthogonal to the outlet passage. The inlet passage and outlet passage may also intersect at a corner. The inlet passage and nozzle may be sized such that when the nozzle is fully received within the inlet passage, an end of the nozzle is positioned substantially flush with the corner. The flow control block may also include a removable plug that when removed from the flow control block opens an access passage that communicates with both the inlet and outlet passages. The outlet passage may include a piston slidably disposed therein that is moveable from a first position to a second position such that in the first position, the inlet passage opens to the outlet passage, and in the second position, the inlet passage is sealed off from the outlet passage by the piston.

In another aspect of the disclosure, a system for dispensing a flowable material from a cartridge having a cartridge body includes a housing. The housing has first and a second ends and an inner surface defining a cavity therebetween sized to receive the cartridge body. The first end has a first cap attached thereto. The second end has a second cap attached thereto. The first cap has an opening extending therethrough and is in communication with the cavity. The system also includes a nozzle integral with or attachable to a dispensing end of the cartridge body and sized to at least partially extend through the opening of the first cap. Additionally, the system includes a flow control block that includes an inner surface that defines a passageway and is connectable to the first cap of the housing such that the opening of the first cap aligns with the passageway. The passageway has an inlet sized to receive a first portion of the nozzle therein.

Additionally the second cap may be hingedly attached to the housing and may be moveable from a first position to a second position in which the second cap applies a force to the cartridge when the cartridge is at least partially disposed within the cavity.

Further, the nozzle may include a second portion. The first portion may have a first cross-sectional dimension smaller than a second cross-sectional dimension of the second portion. The first portion of the nozzle may be tapered and the inner surface of flow control block may include a tapered region that is correspondingly tapered with the first portion such that the force applied by the second cap on the cartridge forms a seal between the first portion and tapered region. Also, a first transverse surface may be defined between first and second portions of the nozzle, and the inlet of the passageway may include first and second sections. The first section may be narrower than the second section, which defines a second transverse surface between the first and second sections. The first section may be sized to receive the first portion and the second section may be sized to receive the second portion such that a gasket positioned about the first portion is compressed between the first and second transverse surfaces when the force is applied on the cartridge by the second cap.

Continuing with this aspect, the second cap may include a cartridge contact surface having a gasket disposed thereon and a cannulated puncture screw extending therefrom. The second cap may be attached to the housing by a lever mechanism. The lever mechanism may include four members and four hinges. Each member may be connected to an adjacent member via one of the four hinges. The second cap may be pivotably attached to a support member via a mounting ball.

In a further aspect of the disclosure, a method for dispensing a flowable material from a cartridge includes loading the cartridge having a nozzle into a housing such that the nozzle extends through an opening at a front-end of the housing and into a flow control block having inlet and outlet passages. The method also includes applying force via an end cap of the housing to an end of the cartridge opposite the nozzle to sealingly mate the nozzle to an inner surface defining the inlet passage of the flow control block, and pressurizing the cartridge.

Additionally, the method may include actuating a piston disposed within the outlet passage from a first position in which the piston blocks the inlet passage from the outlet passage to a second position in which the inlet and outlet passages are in fluid communication.

### BRIEF DESCRIPTION OF THE DRAWINGS

the features, aspects, and advantages of the present invention will become better understood with regard to the following description, appended claims, and accompanying drawings in which:

FIG. 1 is a side view of a dispensing system for dispensing a flowable material including a housing, first cap, second cap assembly, linkage system, and flow control block.

FIG. 2A is an exploded side view of the second cap assembly of FIG. 1.

FIG. 2B is a side view of the second cap assembly and linkage system of FIG. 1 in a closed position.

FIG. 2C is a side view of the second cap assembly and linkage system of FIG. 1 in an open position.

FIG. 3 is an exploded view of one embodiment of a cartridge and nozzle.

FIG. 4A is an exploded cutaway view of the cartridge and nozzle of FIG. 3 and first cap and flow control block of FIG. 1.

FIG. 4B is an assembled cutaway view of FIG. 4A.

FIG. 5A is a front view of the dispensing system of FIG. 1 in a first configuration.

FIG. 5B is a front view of the dispensing system of FIG. 1 in a second configuration.

FIG. 6A is an exploded cutaway view of an alternative embodiment cartridge, nozzle, first cap, and flow control block.

FIG. 6B is an assembled cutaway view of FIG. 6A.

FIG. 7 is side view of a spray nozzle.

### DETAILED DESCRIPTION

As used herein, the terms “about,” “generally” and “substantially” are intended to mean that slight deviations from absolute are included within the scope of the term so modified.

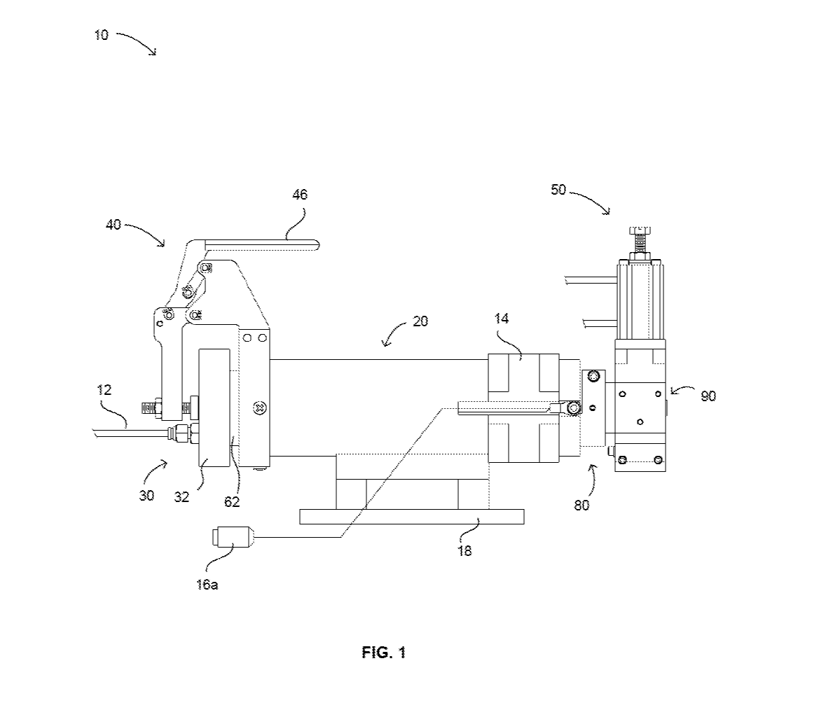

FIG. 1 depicts a dispensing system 10 for dispensing a flowable material, such as adhesive, polymer, epoxy, and the like, from a cartridge. The system generally includes a housing 20 and an extruder 50.

Housing 20 defines a cavity for receipt of a cartridge containing flowable material. The cavity and housing 20 may be shaped to correspond with the shape of the cartridge, such as the cylindrical shape, as depicted, or some other shape, such as a prism. A mount 18 may be attached to housing 20, which allows system 10 to be attached to any number of surfaces, such as a table or a wall, for example. A first cap 80 or front cap is attached at one end of housing 20. A second cap 32 or rear cap is attached at the other end of housing 20.

A band heater 14 may be attached to an outer surface of housing 20. Housing 20 may be made from a conductive material, such as aluminum or steel, for example, which facilitates the transfer of heat through housing 20 to the cartridge from band heater 14. Insulation may be applied to the remainder of the outer surface of housing 20 to reduce heat loss and protect an operator from inadvertent contact. A temperature sensor 16a may be attached to the housing adjacent band heater 14. Temperature sensor 16a may also be connected to a control unit that regulates the temperature of the flowable material.

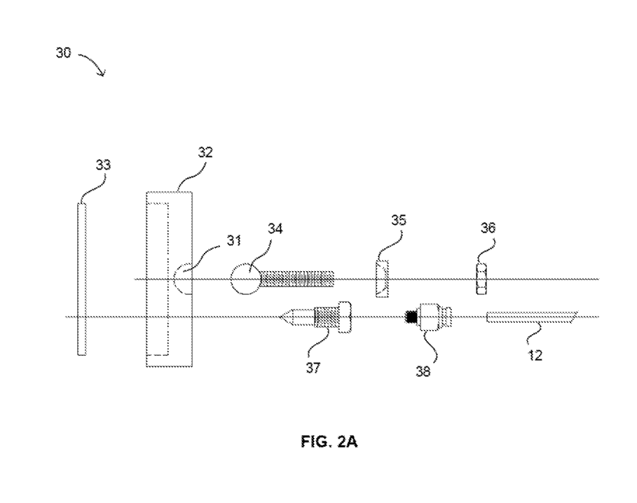

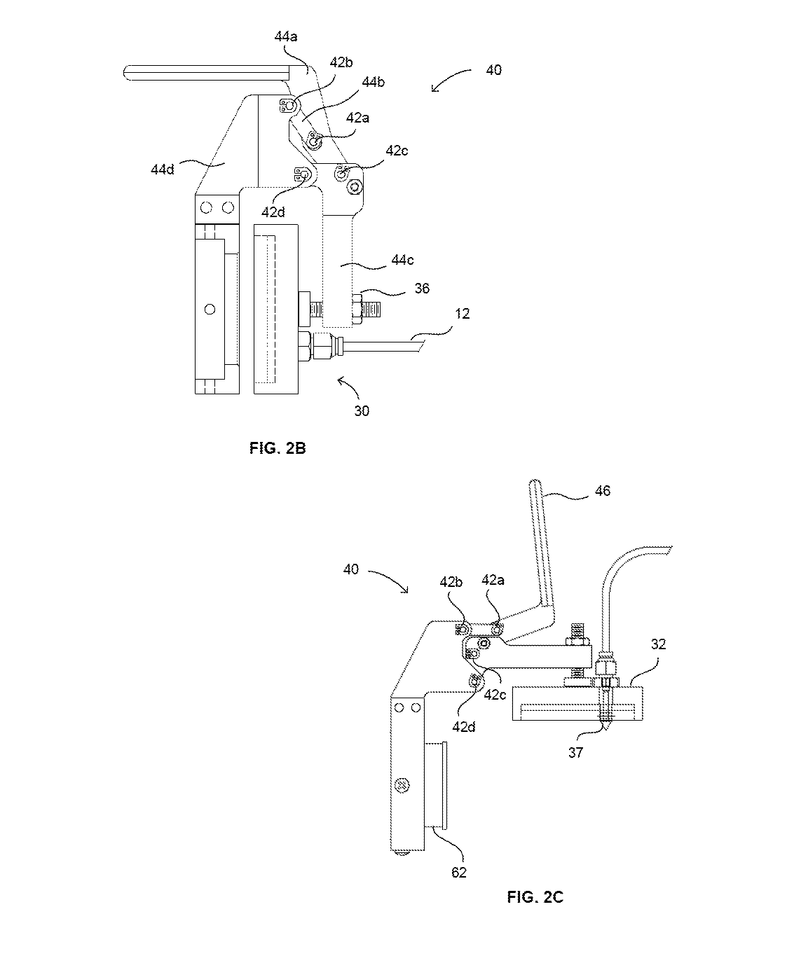

FIG. 2A is an exploded depiction of a second cap assembly 30 that includes second cap 32 and also includes a gasket 33, mounting ball 34 and puncture element 37. Gasket 33 sits within an annular portion of second cap 31 and allows for an air-tight seal around an end of a cartridge.

Mounting ball 34 is fitted into a spherical notch 31 in second cap 31. A retainer 35, also having a spherical notch, is attached to mounting ball 34. Retainer 35 can be adjusted to reduce or increase the amount second cap 32 can pivot about mounting ball 34.

Puncture element 37 is preferably cannulated and extends through second cap 32 from one end to another. An adapter 38 and pneumatic hose 12 is coupled to puncture element 37. Generally, the length of puncture element 37 is such that when a cartridge is sealed by gasket 33, puncture element 37 penetrates through an end of the cartridge at least enough to deliver gas to the inner chamber of the cartridge via pneumatic hose 12.

FIGS. 2B and 2C depict a linkage system 40, which attaches second cap assembly 30 to housing 20 and allows second cap assembly 30 to move between open and closed positions. As shown, linkage system 40 is preferably a four-bar mechanism that has four hinge points 42a-d or pivot points and four linking members 44a-d. Generally, first member 44a has a handle 46 and is attached to second member 44b via first hinge point 42a and to the third member 44c via third hinge point 42c. The second member 44b is attached to the fourth member 44d via the second hinge point 42b, and the fourth member 44d is attached to the third member 44c via the fourth hinge point 42d. The third member 44c also attaches to the second cap 32 via mounting ball 34. Thus, when second cap 32 contacts a cartridge during operation of linkage system 40, second cap 32 can pivot, if needed, to ensure gasket 33 lies flush against the cartridge when second cap 32 is locked down onto the cartridge. A nut 36 secures mounting ball 34 to third member 44c and also allows for axial adjustment of the second cap 32 so that second cap 32 can accommodate cartridges of different lengths. One of the benefits of this linkage system 40 is that it allows mounting ball 34 to be arranged in the center of second cap 32 so that closing forces can be applied from linkage system 40 to the center of second cap 32 via mounting ball 34, which helps evenly seal gasket 33 against the cartridge.

Hinge points 42a-d and linking members 44a-d are arranged in such a way that when second cap 32 is moved into the closed position, second cap 32 applies axial force to a cartridge within housing 20 and linkage system 40 locks second cap assembly 30 in place. In the particular embodiment depicted in FIG. 2A, when first, second, and third pivot points 42a-c align in a substantially linear arrangement, linkage system 40 has reached a locking position in which opposing axial forces applied by the cartridge to second cap 32 are resisted by linkage system 40. As shown in FIG. 2C, when first, second, and third pivot points 42a-c are moved out of linear alignment, which may be achieved by applying upward force to handle 46, second cap 32 can swing freely to allow for the removal of the cartridge and insertion of another cartridge.

While a locking, four-bar mechanism is preferred, other mechanisms utilizing less than or more than four hinge points and linking members are possible. In one alternative embodiment, a linkage system (not shown) may include at least one hinge point that couples second cap assembly 30 to housing 20 and allows second cap assembly 30 to rotate between open and closed positions. Once in a closed position, a threaded element attached to second cap 32 may be threaded into an aperture attached to housing 20 to lock cap 32 in the closed position.

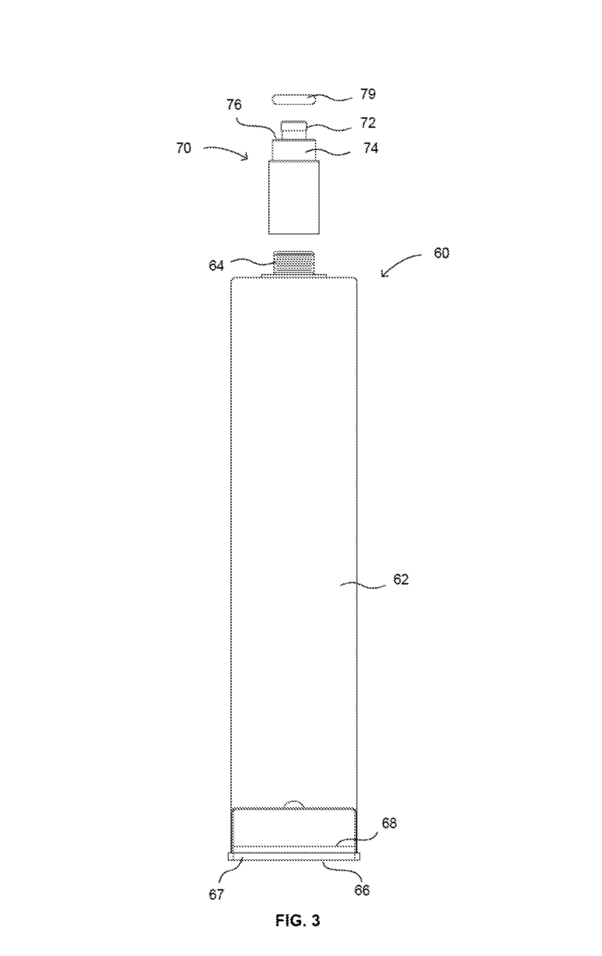

FIG. 3 depicts an exemplary embodiment of a cartridge 60 containing a flowable material and a nozzle 70. Cartridge 60 includes a cartridge body 62, a dispensing end 64, and a working end 66. Cartridge body 62 is preferably made from a metallic material, or some other conductive material, such as aluminum, or an alloy thereof, for example. Dispensing end 64 defines an aperture for passage of the material and is threaded to mate with nozzle 70. However, in some embodiments, nozzle 70 and cartridge body 62 may be integral with each other such that they form as a single, monolithic structure. At the furthest extent of working end 66, a sidewall of cartridge body 62 is rolled to form a rim 67 to provide rigidity and a surface for sealing against gasket 33. Working end 66 also includes a diaphragm plate 68 offset from rim 67. Diaphragm plate 68 generally has a thinner thickness than the sidewall of cartridge body 62 to allow for puncture element 37 to pierce diaphragm plate 68.

Nozzle 70 is generally cylindrical and includes a passageway 78 extending therethrough and a first portion 72 and second portion 74. First portion 72 has a smaller diameter than second portion 76. The difference in diameters forms a transverse surface 76 or shoulder. An O-ring 79 or gasket is fitted about first section 72 and abuts transverse surface 76.

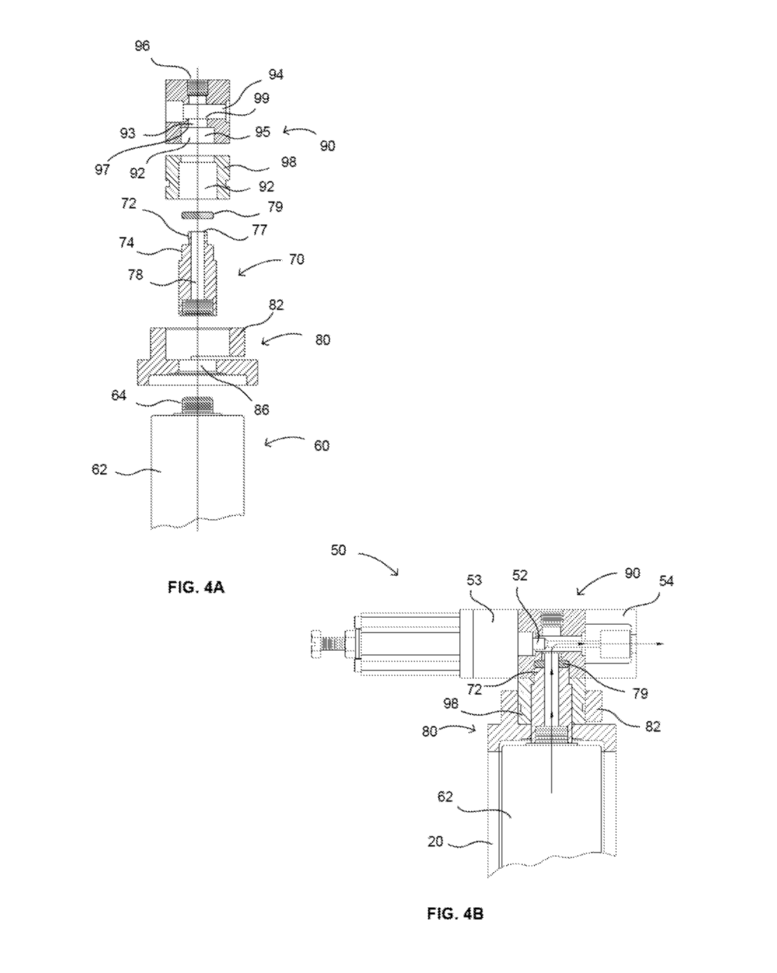

FIGS. 4A and 4B illustrate the end of housing 20 opposite that of second cap assembly 30. At this end of housing 20, first cap 80 is attached thereto. First cap 80 defines an opening 86, which is sufficiently large to allow at least a portion of nozzle 70 to pass therethrough, while prohibiting passage of the cartridge body 62 (best shown in FIG. 4B). First cap 80 also includes an integral locking ring 82 that can be opened and closed for attachment and adjustment of a flow control block, as described further below. In some embodiments, this locking ring 82 may be attachable to first cap 80.

A flow control block 90 is attachable to housing 20 via first cap 80. Flow control block 90 may be provided as a component of an extruder, such as extruder 50 shown in FIG. 4B. However, flow control block 90 may be provided separately and assembled with other extruder components such as a piston 52, piston housing 53, and extruder nozzle 54. Nozzle 70 is generally manufactured to correspond with flow control block 90.

Flow control block 90 includes an inner surface that defines an inlet passage 92 and an outlet passage 94. As depicted, inlet passage 92 and outlet passage 94 intersect at about a perpendicular angle. However, other angles are envisioned such as a 60, 45, 30 or 0 degree angle, for example. Inlet passage 92 extends beyond the intersection with outlet passage 94 where a removable plug 96 is coupled to flow control block 90. Removable plug 96 is preferably threaded into flow control block 90 and can be removed to gain access to inlet and outlet passages 92 and 94 to remove obstructions or for other reasons. Outlet passage 94 extends beyond the intersection with inlet passage 92, which provides a channel for piston 52.

The inner surface of flow control block 90 at inlet passage 92 includes surface features that correspond with the structure of nozzle 70. In the embodiment depicted in FIGS. 4A and 4B, the inner surface at inlet passage 92 includes a first section 93 and a second section 95. First section 93 has a smaller diameter than second section 95. First section 93 corresponds with first portion 74 of the nozzle. Second section 95 corresponds with second portion 74 of nozzle 70. The difference in diameters of first and second sections 93 and forms a transverse surface 97 that corresponds with transverse surface 76 of nozzle 70. Thus, when nozzle 70 is inserted into flow control block 90, first portion 72 resides within first section 93, second portion 74 resides in second section 95, and O-ring 79 is compressed between transverse surfaces 76 and 97 providing for a sealing relationship.

Generally, first portion 72 of nozzle 70 has a length such that the end face 77 of first portion 72 lies substantially flush with a corner 99 formed by the intersection of inlet and outlet passage 92 and 94. This allows for substantially all of the flowable material to flow directly into outlet passage 94, which facilitates an easier clean-up and helps reduce opportunities for obstructions. In addition, since the flowable material is deposited from cartridge 60 directly into flow control block 90, which is attachable to housing 20, flow control block 90 could be easily removed and replaced without having to go through an extensive cleaning process.

While it has been described that nozzle 70 and inlet passage 92 have features with diameters, other shapes, such as a prism, are envisioned. In such a case, the cross-sectional dimension of first section 93 would be smaller than second section 95, and a cross-sectional dimension of first portion 72 of the nozzle would be smaller than a cross-sectional dimension of second portion 74.

Flow control block 90 also preferably includes a mounting adapter 98. This mounting adapter 98 is optional and is attachable to or integral with the remainder of the mounting block structure. This adapter 98 includes also includes an extension of inlet passage 92 and an inner surface that may also include additional features corresponding with nozzle 70. Mounting adapter 98 has a generally cylindrical outer surface and fits within locking ring 82 of first cap 80 (best shown in FIG. 4B). This allows flow control block 90 to be quickly removed and replaced.

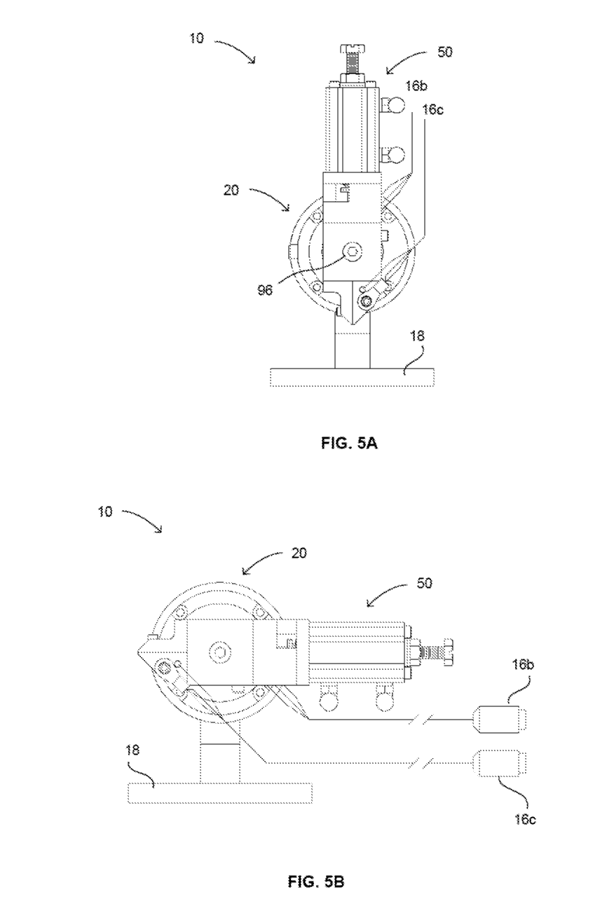

In addition, as shown in FIGS. 5A and 5B, mounting adapter 98 and locking ring 82 allow for flow control block 90 to be rotated to any number of positions relative to housing 20, which provides dispensing system 10 flexibility for mounting in any number of convenient locations. Thus, for example, the configuration of FIG. 5A could be used to mount dispensing system 10 to a table top surface, and FIG. 5B could be used to mount to a wall. Still other configurations can be achieved to mount to other surfaces, such as an overhead surface, for example. Although, hand held operation is contemplated.

Generally, in a method of operation, nozzle 70 is attached to cartridge 60. Cartridge 60 and nozzle 70 are then loaded into the cavity of housing 20 such that nozzle 70 at least partially passes through opening 86 of first cap 80 and into flow control block 90. Handle 46 is actuated to operate linkage system 40 and move second cap assembly 30 into the closed position. While handle 46 is actuated, puncture element 37 punctures diaphragm plate. When the locking position is reached, pivot points 42a-c align in a substantially linear arrangement, gasket 33 seals against rim 67, and second cap 32 applies axial force to cartridge 60 helping portions 72 and 74 of nozzle 70 interface with the inner surface of inlet passage 92 of flow control block 90 to form a sealing relationship.

More specifically, in the method of operation, flow control block 90 is connected to housing 20 by inserting mounting adapter 98 into locking ring 82 while locking ring 82 is in an open configuration. Flow control block 90 is rotated to the desired orientation, and locking ring 82 is tightened to a closed configuration.

Cartridge 60 is obtained, and nozzle 70 is attached to dispensing end 64 of cartridge 60. Of course, in some embodiments where nozzle 70 is integral with cartridge body 62, this step can be skipped. With linkage system 40 and second cap assembly 30 in the open position, cartridge 60 is inserted into the cavity of housing 20. Nozzle 70 partially passes through opening 86 in first cap 80, first portion 72 of nozzle enters into first section 93 of flow control block 90, second portion 74 enters into second section 95 of flow control block 90, and gasket 33 contacts both transverse surfaces 76 and 97.

Thereafter, the linkage system 40 is actuated via handle 46, which moves second cap assembly 30. Penetration element 37 contacts diaphragm plate 68 of cartridge 60, which then provides some resistance to the operator. Additional force may be applied, which pierces diaphragm 68. When gasket 33 contacts rim 67, second cap 32 may pivot about mounting ball 34 until gasket 33 is fully aligned with rim 66. Force is continuously applied to handle 46 until the first, second, and third pivot points 42a-c are aligned, as shown in FIGS. 1 and 2B. At this point, second cap assembly 30 is locked into position and applies axial force to cartridge 60, which helps provide a sealing engagement between nozzle 70 and flow control block 90 to prohibit leakage of the flowable material. If need be, nut 36 can be adjusted to move second cap 32 closer to housing 20 or further away in order to accommodate cartridges 60 of various lengths.

Gas is pumped through puncture element 37 to pressurize the internal contents of cartridge 60. Housing 20 enhances the cartridge's structural integrity during this process. In addition, linkage system 40 resists additional loads applied by the dispensing and pressurization. Depending on the material being dispensed, band heater 14 may transfer heat to the material within cartridge 60 to enhance flowabilty.

Piston 52 of extruder 50 may be pneumatically or electrically controlled and may be automated such that material dispenses for a precise duration at precise intervals. Alternatively, an operator may have a foot pedal to actuate piston 52, which allows the operator to utilize both hands to control a workpiece during operation. The piston's operation may be calibrated to dispense a precise amount of flowable material giving the operator repeatable results.

When the material is dispensed, it exits nozzle 70 and enters directly into outlet passage 94 of flow control block 90 and then dispensed to the outside. In the event a different extruder or flow control block is desired, flow control block 90 can be quickly removed by opening locking ring 82. Additionally, adjustments may be made by the operator to the orientation of flow control block 90 with respect to housing 20. Once cartridge 60 is empty, linkage system 40 is actuated to open second cap assembly 80 and a new cartridge is inserted thereafter with minimal downtime.

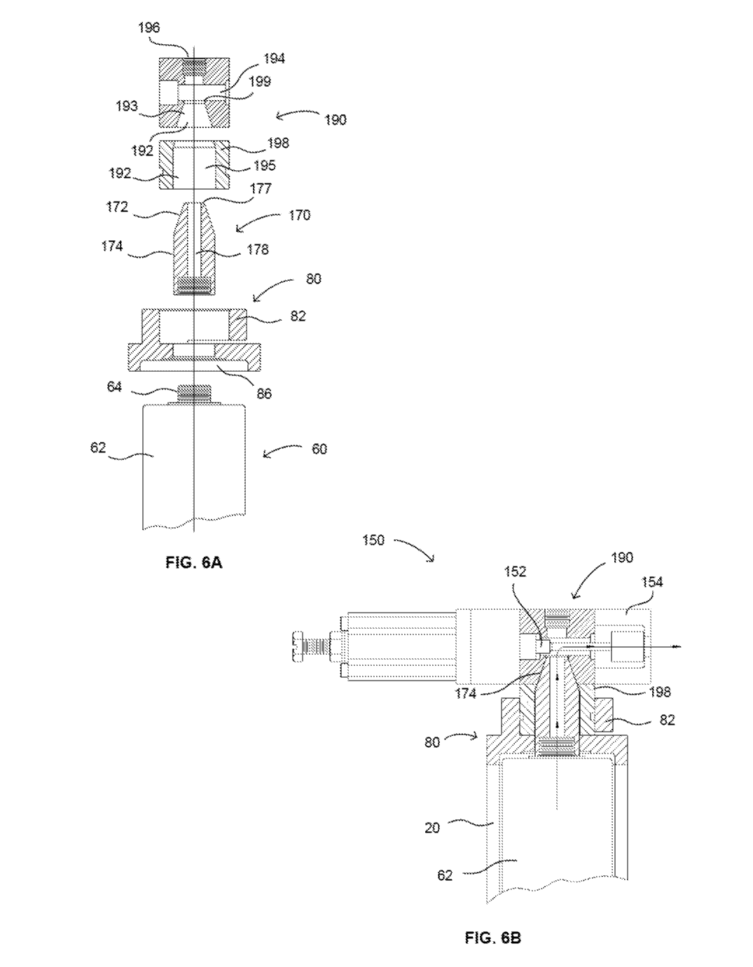

FIGS. 6A and 6B depict alternative embodiment control block 190 and nozzle 170. Housing 20, first cap 80, and cartridge 60 may be utilized with these alternative embodiments. Nozzle 170 includes a passageway 178, a first portion 172, and a second portion 174. Similar to nozzle 70, first portion 172 has a smaller cross-sectional dimension than second portion 174. Differing from nozzle 70, first portion 172 is tapered like a cone.

Flow control block 190 is similar to flow control block 90 with the difference being that the inner surface of inlet passage 192 is specifically configured to correspond with first and second portions 172, 174 of nozzle 170. Thus, first portion 172 and first section 193 are correspondingly tapered to provide a taper-lock when fully engaged. This taper-lock provides a sealing relationship to prohibit the flowable material from leaking through this tapered interface during operation. In such a relationship, an O-ring may not be needed.

The method of using these alternative embodiments is substantially similar with the difference being the interaction between flow control block 190 and nozzle 170 is slightly modified due to their alternative geometries.

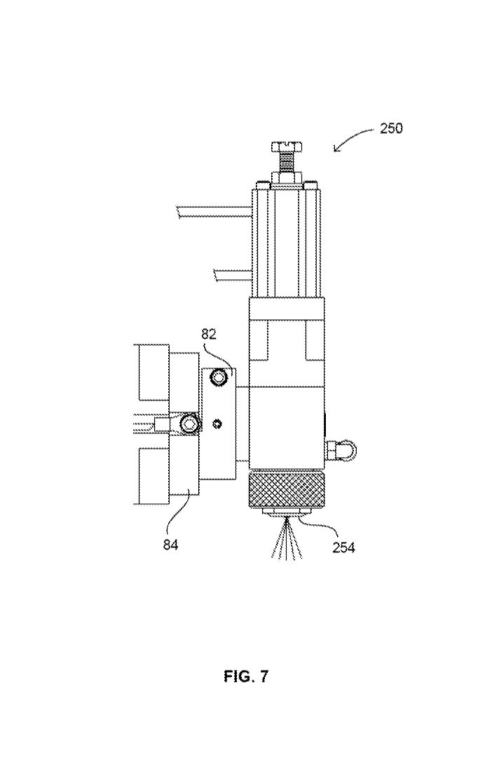

FIG. 7 depicts a spray head 250 that can be used in lieu of extruder 50. Flow control blocks 90 and 190 described above can be utilized in such a spray head. For instance, flow control block 90 or 190 could be provided with a piston mounted thereto and a spray nozzle 254 or extruder nozzle 54 could be interchangeably connected to these flow control blocks. Alternatively, standard extruders and spray heads could be modified by assembling a flow control block therewith. As such, the dispensing system described provides flexibility to the operator.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for dispensing a flowable material from a cartridge body, comprising:
a housing for receiving the cartridge body;
a nozzle being one of attachable to or integral with a dispensing end of the cartridge body and having an inner surface defining a passageway for the flowable material and an outer surface; and
a flow control block attachable to the housing and having an inner surface defining in inlet passage and an outlet passage, the inlet passage being sized to receive at least a portion of the nozzle therein, the inner surface of the flow control block being configured to mate with the outer surface of the nozzle in a sealing relationship when the at least a portion of the nozzle is disposed within the inlet passage.

2. The system of claim 1, wherein:
the housing includes an inner surface defining a cavity for receipt of the cartridge body and a first end having a first cap attached thereto, the first cap having an opening in communication with the cavity, the opening being sized to allow passage of the at least a portion of the nozzle through the opening while prohibiting passage of the cartridge body, and the flow control block is attachable to the first end of the housing such that the inlet passage aligns with the opening of the first cap.

3. The system of claim 2, wherein the housing includes a second end having a second cap attachable thereto, the second cap being movable from a first position to a second position in which the second cap presses against the cartridge body when the cartridge body is at least partially disposed within the cavity of the housing.

4. The system of claim 3, wherein:
the second cap is attached to the second end via a linkage system having a plurality of pivot locations, and
when the second cap is in the second position at least three of the plurality of pivot locations substantially align in a linear alignment to lock the second cap into the second position.

5. The system of claim 1, wherein:
the housing includes a locking ring at a first end thereof having an open position and a closed position,
the flow control block includes a mounting adapter positionable within the locking ring, and when the mounting adaptor is positioned with the locking ring, the locking ring and flow control block are rotatable with respect to the housing while the locking ring is in the open position and prohibited from rotation with respect to the housing while the locking ring is in the closed position.

6. The system of claim 1, wherein the outer surface of the nozzle includes a first tapered region and the inner surface of the flow control block includes a second tapered region, the first and second tapered regions being correspondingly tapered.

7. The system of claim 1, wherein:
the outer surface of the nozzle defines a first mating region that is normal to a longitudinal axis defined by the passageway of the nozzle, and the inner surface of the flow control block includes a second mating region that is normal to a longitudinal axis defined by the inlet passage, the first and second mating regions being correspondingly sized so as to compress a gasket therebetween.

8. The system of claim 1, wherein the inlet passage is orthogonal to the outlet passage.

9. The system of claim 8, wherein the inlet passage and outlet passage intersect at a corner and the inlet passage and nozzle are sized such that when the nozzle is fully received within the inlet passage, an end of the nozzle is substantially flush with the corner.

10. The system of claim 8, wherein the flow control block includes a removable plug that when removed from the flow control block opens an access passage that communicates with both the inlet and outlet passages.

11. The system of claim 8, wherein the outlet passage includes a piston slidably disposed therein that is moveable from a first position to a second position such that in the first position, the inlet passage opens to the outlet passage, and in the second position, the inlet passage is sealed off from the outlet passage by the piston.

12. A system for dispensing a flowable material from a cartridge having a cartridge body, comprising:
a housing having first and a second ends and an inner surface defining a cavity therebetween sized to receive the cartridge body, the first end having a first cap attached thereto, the second end having a second cap attached thereto, the first cap having an opening extending therethrough and being in communication with the cavity;
a nozzle being one of integral with or attachable to a dispensing end of the cartridge body and sized to at least partially extend through the opening of the first cap; and
a flow control block having an inner surface defining a passageway and being connectable to the first cap of the housing such that the opening of the first cap aligns with the passageway, the passageway having an inlet sized to receive a first portion of the nozzle therein.

13. The system of claim 12, wherein the second cap is hingedly attached to the housing and is moveable from a first position to a second position in which the second cap applies a force to the cartridge when the cartridge is at least partially disposed within the cavity.

14. The system of claim 12, wherein the nozzle includes a second portion, the first portion having a first cross-sectional dimension smaller than a second cross-sectional dimension of the second portion.

15. The system of claim 14, wherein the first portion of the nozzle is tapered and the inner surface of flow control block includes a tapered region that is correspondingly tapered with the first portion such that the force applied by the second cap on the cartridge forms a seal between the first portion and tapered region.

16. The system of claim 14, wherein:
a first transverse surface is defined between first and second portions of the nozzle, and the inlet of the passageway includes first and second sections, the first section being narrower than the second section, which defines a second transverse surface between the first and second sections, the first section being sized to receive the first portion and the second section being sized to receive the second portion such that a gasket positioned about the first portion is compressed between the first and second transverse surfaces when the force is applied on the cartridge by the second cap or back-end cap.

17. The system of claim 14, wherein the second cap includes a cartridge contact surface having a gasket disposed thereon and a cannulated puncture screw extending therefrom, the second cap being attached to the housing by a lever mechanism.

18. The system of claim 17, wherein the lever mechanism includes four members and four hinges, each member being connected to an adjacent member via one of the four hinges.

19. The system of claim 17, wherein the second cap is pivotably attached to a support member via a mounting ball.

20. A method for dispensing a flowable material from a cartridge, comprising:
loading the cartridge having a nozzle into a housing such that the nozzle extends through an opening at a front-end of the housing and into a flow control block having inlet and outlet passages;
applying force via an end cap of the housing to an end of the cartridge opposite the nozzle to sealingly mate the nozzle to an inner surface defining the inlet passage of the flow control block; and
pressurizing the cartridge.
